(19) United States
(12) Patent Application Publication
(10) Pub. No.: US 2016/0055476 A1
(43) Pub. Date: Feb. 25, 2016

(54) LOCATION-BASED SERVICE PAYMENT AND SETUP

(71) Applicant: PAYPAL, INC., San Jose, CA (US)

(72) Inventor: Dustin Culton, Omaha, NE (US)

(21) Appl. No.: 14/930,584

(22) Filed: Nov. 2, 2015

Related U.S. Application Data
(63) Continuation of application No. 13/210,063, filed on Aug. 15, 2011.

(51) Int. Cl. G06Q 20/32; G06Q 20/40; G06Q 20/42

(52) U.S. Cl. CPC G06Q 20/3224; G06Q 20/42; G06Q 20/407

(57) ABSTRACT

Payments are made to service providers for services rendered at a specific user location when the user is detected at that location. This may be when the user's mobile device is detected at a house or business that the user is responsible for service payments. The user may be asked, through the mobile device, whether to make a payment. The request may only be sent when a payment is due. In another embodiment, services are set up for the user when a new address is detected for the user. Specific services may be set up depending on the location and/or user information, such as services utilized by the user at a previous location.

### CROSS REFERENCE TO RELATED APPLICATION

This application is a continuation patent application of U.S. patent application Ser. No. 13/210,063 filed on Aug. 15, 2011, the complete disclosure of which is incorporated by reference in its entirely.

### BACKGROUND

1. Field of the Invention

The present invention generally relates to mobile payments and more particularly to a location-based payment system.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile payments are growing very quickly.

However, not all payments can be made easily from a user's mobile device. For example, the user typically has to access a site or app, select one or more items or services for purchase, and then go through a payment flow on the mobile device. Furthermore, because mobile payments are a recent option, there are many payments not yet possible with a mobile device. A trend exists for the user to be able to increase payment capabilities on a mobile device.

Therefore, it is desirable to allow the user to make payments through a mobile device easily and for different situations.

### SUMMARY

According to one embodiment, a method for making a location-based payment includes determining a location of the user through the user's mobile device, determining that one or more services associated with the location and/or user has a payment due or has a payment that can be made, requesting from the user through the mobile device a confirmation to make a payment for the service, and processing the payment upon confirmation from the user through the user device. In one embodiment, the service is a utility, such as gas, water, or electricity, waste disposal, phone/Internet/television service, gardening service, maid service, etc. The payment can be made automatically or after a confirmation by the user.

In another embodiment, an address change is detected by a service provider. Detection can be through determining that the user's mobile device has moved from a previous “home” location to a new location, such as the mobile device being predominantly around this new location. Detection can also be by the user notifying the service provider. Regardless, upon detection, the service provider may determine which utilities and services may need to be set up, notify the various providers, and obtain information needed to set up the utilities and services. The user may then quickly and easily set up the utilities and services, such as through the user's mobile device, a user computing device, by telephone, or by mail. Once set up, services and utilities can be paid conventionally or using the location-based payment idea in the earlier embodiment.

As a result, a user can quickly and easily set up utilities and other services at a new location and make payments automatically when the user is detected at the location.

These and other features and advantages of the present disclosure will be more readily apparent from the detailed description of the embodiments set forth below taken in conjunction with the accompanying figures.

### BRIEF DESCRIPTION OF THE FIGURES

FIG. 1 is a flowchart illustrating a method for the user to make payments based on user location through a payment provider according to one embodiment;

FIG. 2 is a flowchart illustrating a method for the user to set up a service and make payments based on user location according to one embodiment;

FIG. 3 is a block diagram of a networked system used in the payment system described above according to one embodiment

FIG. 4 is a perspective view of a user device according to one embodiment;

FIG. 5 is a block diagram of a computer system suitable for implementing one or more devices described herein; and

FIG. 6 is a block diagram of a user device, payment provider device, and/or an account provider device according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment, a system and method are provided for making payments based on the location of a user. A payment instruction designates a recipient account, includes a payment location, and is associated with a user account. When a user device that is associated with the payment instruction and/or user account is determined to be in the payment location, a payment request to make a payment from the user account to the recipient account is sent over a network. In one embodiment, a user is detected to be at a location where the user is responsible for paying for one or more services or utilities. Upon detection, a payment provider determines which recipient accounts are associated with the user and the location. Payments are then made accordingly. For example, the user may allow automatic payments to be made for certain recipients and/or certain amounts, and/or the user may be requested to confirm or authorize a payment first. Thus, a system and method allow a user to make payments to a recipient by simply being at a designated location.

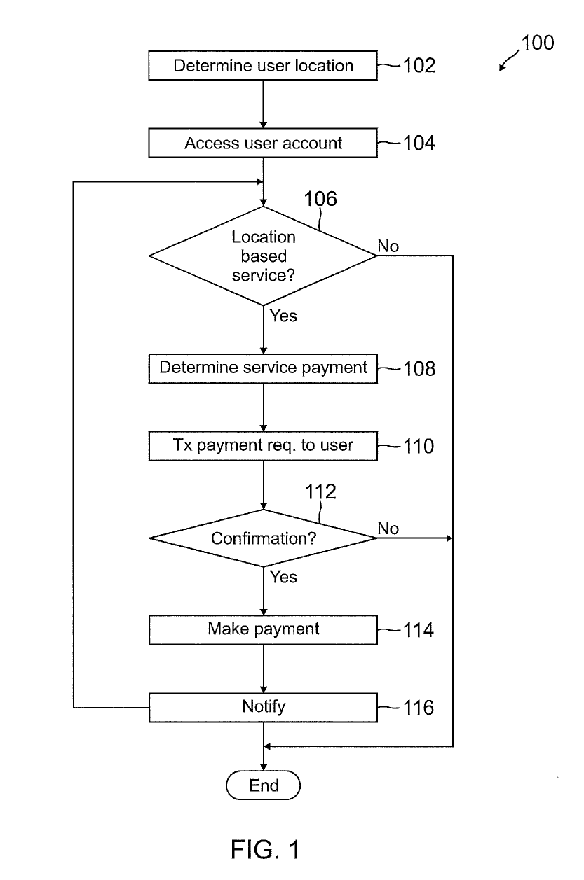

FIG. 1 is a flowchart illustrating a method 100 for the user to make payments based on user location through a payment provider, such as PayPal, Inc. of San Jose, Calif., according to one embodiment. At step 102, a user location is determined. This can be done in any number of ways. In one embodiment, the user enters a specific location on the user's computing device, such as a mobile device, PC, tablet, etc. The user may enter a specific address, select an address from a map or menu, enter coordinates, enter a zip code, etc. In another embodiment, the payment provider may determine the location through the user's mobile device, such as a smart phone or tablet.

Next, at step 104, the payment provider accesses the user's account with the payment provider. The payment provider may access the user's account based on information received from the user directly or through the user's device. The user may enter a user identifier, such as a user name or email. The device may communicate a device identifier, such as a mobile phone number or other device ID. Using this information, the payment provider may locate the user's account associated with the received identifier. Note that steps 102 and 104 (as well as other steps described herein) can be performed in any suitable sequence and/or combined as desired.

Once accessed, the service provider determines, at step 106, whether there are any location-based service payments associated with the account and the user's location as determined at step 102. A location-based service payment, as used herein, is a payment for a service based on a specific location. Examples of services include, but are not limited to, a gas payment a water payment, an electricity payment, a phone payment, a trash collection payment, a pool service payment, a gardening/landscaping payment, a bottled water payment, an Internet provider payment, a cable or satellite TV service payment, a cleaning service payment, etc. A particular payment can be associated with a specific address or location corresponding to a house, business, building, RV, boat, airplane, etc. Each specific address or coordinates may be associated with a named location, such as “My House,” “My Son's Home,” “My Toy Business,” “My Building on Main Street,” “My Wife's Jewelry Business,” etc.

Based on the detected or received user location, the payment provider determines whether any of the location-based service payments are associated with the location. For example, the payment provider may determine that the user is at the user's house and that there are several service payments associated with the user's house, such as an electricity payment, an Internet services provider payment, and a gardener's payment. Thus, at step 108, the service provider determines a specific service payment for the location. With multiple service payments, the payment service may identify the first one based on a user set preference, the service with the most recent payment due date, the service with the most amount due, randomly, or any other selection criteria. Continuing with the above example, the payment provider selects the electricity payment at step 108. The payment provider may determine if any payment is due, even though a location-based service is found. For example, the user may have already made a payment for electricity for this pay period. In that case, the payment provider would not proceed, but may instead go to the next location-based payment service. This prevents the user with being presented with payment requests each time the user is at a location associated with a payment or with having unnecessary payments being when the user is at the location.

Next, at step 110, the payment provider transmits details to the user for a payment to the electric company. The transmission may be to the user's mobile device, such as through an email, text, or voice message. Details may include the name of the payee (the electric company), the amount, and the electricity account information, such as the name and/or address associated with the electricity service. Additional details may include a payment date, which may default to the due date or the current date. The user may also have the option of changing the payment date or payment amount.

There may also be a means for the user to accept or cancel the payment, such as one or more buttons, links, fields for user to enter, etc. The user conveys an acceptance or cancellation, such as through data entry, a text, voice, or other means conveyed to the payment provider. The user may be asked to log into the user's account with the payment provider at some point, which may be any time before payment is made. Log in may include the user entering a user identifier, such as a user name or email address, and a PIN or password.

Upon receiving the user communication, the payment provider determines, at step 112, whether the user has confirmed payment. Confirmation may include receiving proper log in credentials from the user and/or any changes to the payment request, such as amount or date.

When the payment request is confirmed, the payment provider makes the payment to the payee (the electric company) at step 114. This may include the user's account being debited the appropriate amount and an account of the payee being credited an appropriate amount. The amount debited from the user's account may be credited to the payment provider (or the payee account) through one of a plurality of user funding sources, such as a credit card, a bank account, or a debit card. The amounts do not need to match, as fees may be imposed by the payment provider on the user and/or the payee for using the location-based payment service.

Note that steps 110 and 112 may be omitted in certain embodiments. In those embodiments, the user may have designated certain payments to be made automatically if conditions are met. For example, certain services may have automatic payments, such as utilities, to a certain amount, within a certain due date, and/or within a certain location (e.g., service payments at a business are automatically paid, but not payments at a user's vacation home), within a certain time of the day, etc.

Next, the user and/or the payee may be notified at step 116. Notification may include sending a confirmation to the user device that payment was made, including details of the payment. A receipt may be sent to and stored on the user's mobile device as well. The payee may also be notified, such as a message sent that a payment was made from the user, with account information and amount. The process may continue if there are more location-based services at the user location available for payment. In the above example, the user may be notified a payment for the user's Internet services provider, followed by a notification of a payment for the user's gardening service. These can all result in a payment made to those services.

As a result, a user is able to quickly and easily make payments for services based on the user location. The user does not need to remember to make a service payment, write a check, or other tasks typically associated with making service payments.

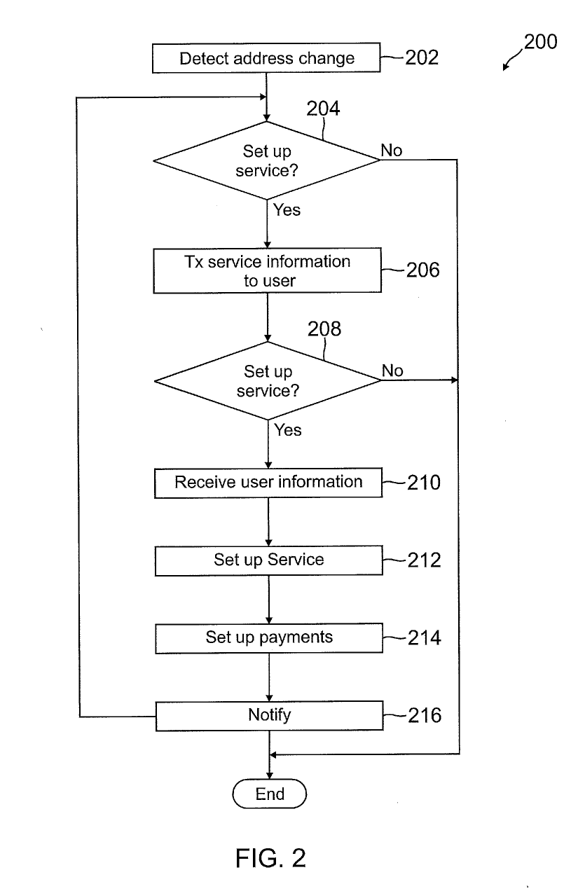

FIG. 2 is a flowchart illustrating a method 200 for the user to set up a service and make payments based on user location according to one embodiment. At step 202, an address change is detected. Detection of address change can be done in any number of ways. In one embodiment, the payment provider detects that the user is at a certain location over several consecutive nights, such as through the user's mobile device, where the certain location is different than the home location associated with the user's account with the payment provider. The number of consecutive nights or X number of nights over a period of Y days may result in the payment provider asking the user if the user has moved. In another embodiment, the user enters information indicating that the user has changed addresses, such as entering a new address with the post office, the payment provider, or any other database that may be accessible by the payment provider.

Once an address change is detected, the new address is noted, which may be a number, street name, city, country, zip code, and/or longitude and latitude coordinates. The payment provider may determine, at step 204, whether a certain service should be set up at the new address. The determination may be simply sending a request to the user through the user's mobile device, including information about the service and the new service address, and then receiving a communication from the user device whether to proceed with service set-up at the new location.

Determining which service(s) are available to the user or sent to the user for set-up may be based on several factors. These include, but are not limited to, the services the user had or has at the previous address and necessary utilities for the new location. For the former, the payment provider may access the user's account to determine which services the user has been paying for through the payment provider. For the latter, the payment provider may determine that utilities, such as gas, electricity, and water are necessary and determine the one or more providers of those services at the new location. The payment provider may also determine that an Internet or phone service provider is also desirable, as well as a television cable or satellite provider. The various service providers may have a relationship with the payment provider, such that the payment provider may offer users the ability to set up and pay for the services through the payment provider.

If the user wishes to set up (or transfer) service based on the user's new location or address, the payment provider transmits service information to the user at step 206. Note that setting up a service includes both setting up a new service and transferring an old service, as used herein. Transmission can be to the user's mobile device or other computing device, such as a PC or tablet. Service information can include the various options for the service (e.g., none for utilities, but different options for satellite television) and costs associated with the various options. A more detailed of the service can also be provided.

A determination is then made, at step 208, whether the user wishes to set up the particular service. This can be determined by receiving an indication from the user, such as from one or more buttons, links, or fields for user to enter. For example, the user may simply select a “Set-up” button or “No thanks” button. The user may also convey the response data entry, a text, voice, or other means.

If the payment provider determines the user wishes to set up the particular service, the payment provider may send the user a request for certain information. The requests may include service address, user name, funding instrument, phone number, service option (if available), etc. Some of this information may be available to the payment provider, so that certain fields may be pre-populated, which the user can change if desired. For example, the payment provider may already have most of the user information for the service at the user's previous address, information from the user's payment provider account, the new address location, etc.

The user enters and transmits the requested information, along with any pre-populated information, back to the payment provider, which receives the user information at step 210. The payment provider may re-transmit the information and ask the user to confirm the information. Once the desired or requested information is received, the payment provider sets up the service, at step 212, on behalf of the user. Service set up may be done directly by the payment provider or by the service provider. For example, the payment provider may have an agreement with the service provider (and user) that allows the payment provider to set up the account for the user. This may involve communicating with the service provider to complete the set up or transfer process. In another example, the payment provider may communicate the user information to the payment provider, who then processes the information and finalizes the set up with the user, such as requesting the user to confirm a final step to set up service.

Along with service set up, the payment provider may also set up payments for the service at step 214. This may include automatic payments on a specific date, reminders sent to the user, or a location-based payment as described with respect to FIG. 1.

Next, at step 216, the user and/or the service provider may be notified. Notification ca be to the user's mobile device or other user device, such as a PC or tablet. The notification can be through text, email, or voice and include details of the service, such as account number, along with any payment options.

If other services can still be set up, the process may be repeated starting at step 204. As a result, the user is able to quickly and easily set up services when an address change is detected. This provides numerous benefits, including the user not having to locate the various services and utilities when moving to a new location, the user being able to set up services through the user's mobile device, the user being able to set up all services through a single entity (the payment provider), and the user being able to set up a payment process through the payment provider automatically.

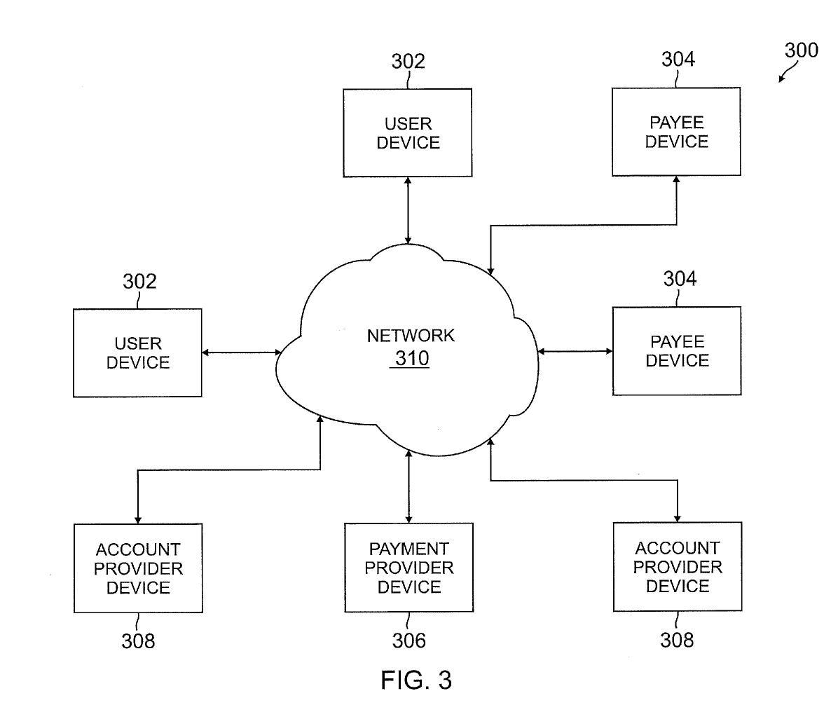

FIG. 3 is a block diagram of a networked system 300 used in the payment system described above according to one embodiment. Networked system 300 includes a plurality of user devices 302, a plurality of payee (or service provider) devices 304, a payment provider device 306, and a plurality of account holder devices 308 in communication over a network 310. Any of user devices 302 may be the user device, discussed above. Payee devices 304 may be associated and/or operated by the service providers discussed above. Payment provider device 306 may be operated by a payment service provider such as, for example, PayPal Inc. of San Jose, Calif. Account provider devices 308 may be operated by the account providers discussed above such as, for example, credit card account providers, bank account providers, savings account providers, and a variety of other account providers known in the art.

User devices 302, payee devices 304, payment provider device 306, and account provider devices 308 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of system 300, and/or accessible over network 310.

Network 310 may be implemented as a single network or a combination of multiple networks. For example, in various embodiments, network 310 may include the Internet and/or one or more intranets, landline networks, wireless networks, and/or other appropriate types of networks.

User device 302 may be implemented using any appropriate combination of hardware and/or software configured for wired and/or wireless communication over network 310. For example, in one embodiment, user device 302 may be implemented as a personal computer of a user in communication with the Internet. In other embodiments, user device 302 may be a smart phone, personal digital assistant (PDA), laptop computer, tablet, and/or other types of computing devices.

User device 302 may include one or more browser applications which may be used, for example, to provide a convenient interface to permit the payer to browse information available over network 310. For example, in one embodiment, the browser application may be implemented as a web browser configured to view information available over the Internet.

User device 302 may also include one or more toolbar applications which may be used, for example, to provide user-side processing for performing desired tasks in response to operations selected by the payer. In one embodiment, the toolbar application may display a user interface in connection with the browser application.

User device 302 may further include other applications as may be desired in particular embodiments to provide desired features to user device 302. In particular, the other applications may include a payment application for payments assisted by a payment provider through payment provider device 306. The other applications may also include security applications for implementing user-side security features, programmatic user applications for interfacing with appropriate application programming interfaces (APIs) over network 310, or other types of applications. Email and/or text applications may also be included, which allow the user to send and receive emails and/or text messages through network 310. User device 302 includes one or more user and/or device identifiers which may be implemented, for example, as operating system registry entries, cookies associated with the browser application, identifiers associated with hardware of user device 302, or other appropriate identifiers, such as a phone number. In one embodiment, the user identifier may be used by payment provider device 306 and/or account provider device 308 to associate the user with a particular account.

Payee device 304 may be maintained, for example, by a service provider offering various services and/or products in exchange for payment to be received conventionally or over network 310, such as described herein. In this regard, payee device 304 may include a database identifying available services which may be made available for viewing, setup, and purchase by the user.

Payee device 304 also includes a checkout application which may be configured to facilitate the purchase by the user of services. The checkout application may be configured to accept payment information from the user through user device 302, the account provider through account provider device 308, and/or from the payment provider through payment provider device 306 over network 310.

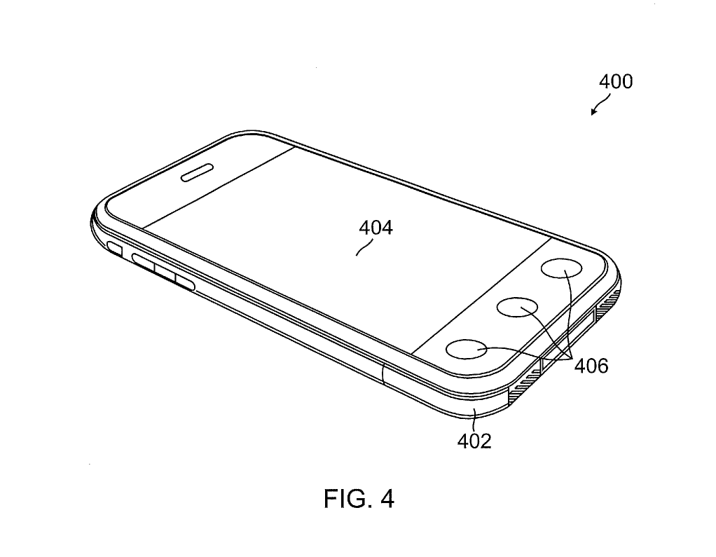

FIG. 4 shows an embodiment of a user device 400. User device 400 may be user devices 302 shown in FIG. 3. User device 400 includes a chassis 402 having a display 404 and an input device including display 404 and a plurality of input buttons 406. One of skill in the art will recognize that user device 400 is a portable or mobile phone including a touch screen input device and a plurality of input buttons that allow the functionality discussed above with reference to the methods in FIGS. 1 and 2. However, a variety of other portable/mobile payer devices and/or desktop payer devices may be used in the methods departing from the scope of the present disclosure.

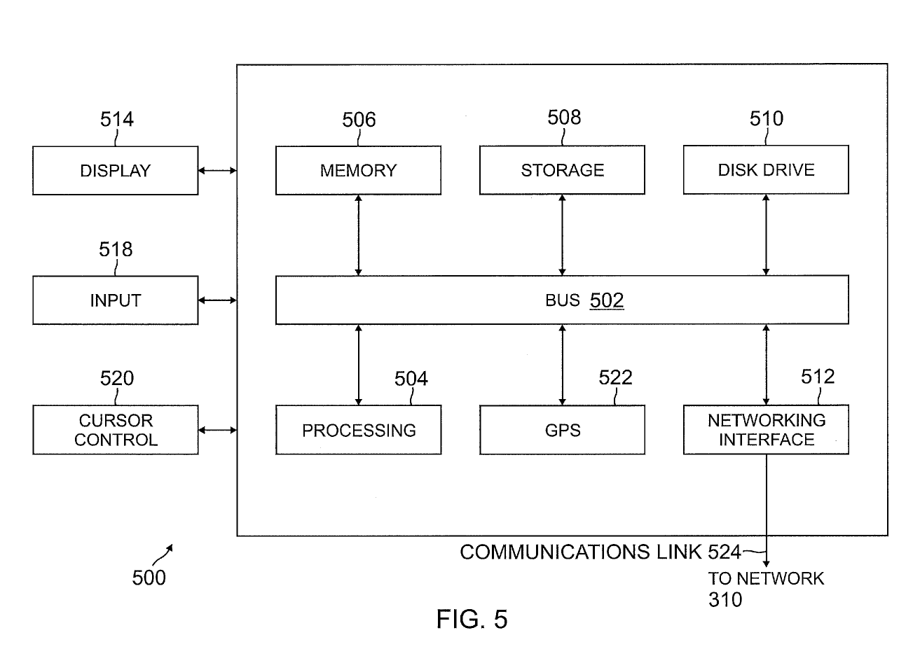

FIG. 5 is a block diagram of a computer system 500 suitable for implementing, for example, user device 302, payer device 400, payee devices 304, payment provider device 306, and/or account provider devices 308, is illustrated. It should be appreciated that other devices utilized by user or payer, payees, payment providers, and account providers in the payment system discussed above may be implemented as computer system 500 in a manner as follows.

In accordance with various embodiments of the present disclosure, computer system 500, such as a computer and/or a network server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 518 (e.g., keyboard, keypad, or virtual keyboard), a cursor control component 520 (e.g., mouse, pointer, or trackball), and/or a location determination component 522 (e.g., a Global Positioning System (GPS) device as illustrated, a cell tower triangulation device, and/or a variety of other location determination devices known in the art). In one implementation, disk drive component 510 may comprise a database having one or more disk drive components.

In accordance with embodiments of the present disclosure, computer system 500 performs specific operations by processor 504 executing one or more sequences of instructions contained in memory component 506, such as described herein with respect to the user device, the payee device(s), the payment provider device, and/or the account provider device(s). Such instructions may be read into system memory component 506 from another computer readable medium, such as static storage component 508 or disk drive component 510. In other embodiments, hard-wired circuitry may be used in place of or in combination with software instructions to implement the present disclosure.

Logic may be encoded in a computer readable medium, which may refer to any medium that participates in providing instructions to processor 504 for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component 510, volatile media includes dynamic memory, such as system memory component 506, and transmission media includes coaxial cables, copper wire, and fiber optics, including wires that comprise bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by computer system 500. In various other embodiments of the present disclosure, a plurality of computer systems 500 coupled by a communication link 524 to network 310 (e.g., such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 524 and network interface component 512. Network interface component 512 may include an antenna, either separate or integrated, to enable transmission and reception via communication link 524. Received program code may be executed by processor 504 as received and/or stored in disk drive component 510 or some other non-volatile storage component for execution.

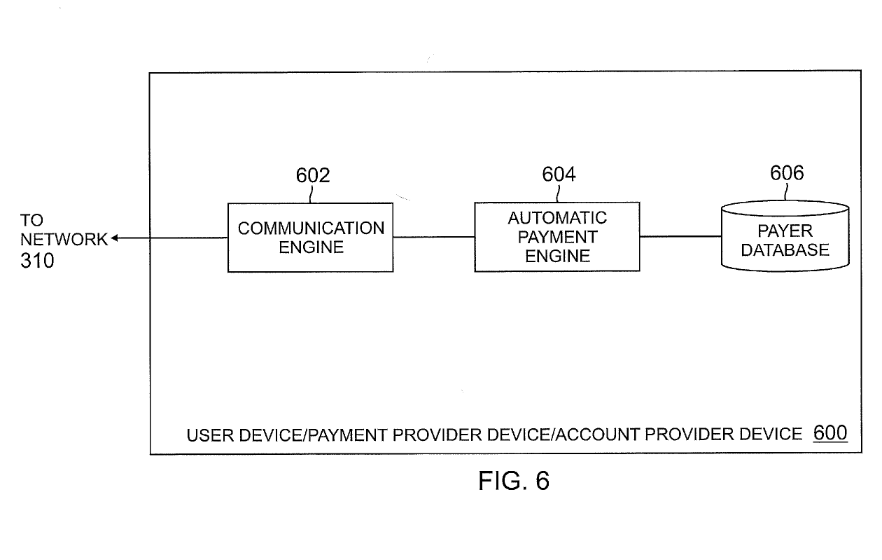

FIG. 6 shows a user device/payment provider device/account provider device 600 according to one embodiment. In an embodiment, device 600 may be user device 302, payment provider device 306, and/or account holder device 308. Device 600 includes a communication engine 602 that is coupled to network 310 and to an automatic payment engine 604 that is coupled to a payer database 606. Communication engine 602 may be software or instructions stored on a computer-readable medium that allows device 600 to send and receive information over network 310. Automatic payment engine 604 may be software or instructions stored on a computer-readable medium that is operable to receive payment instructions (automatic or requiring a confirmation), payment locations, and payment details and associate them with user accounts in database 606, receive payment locations to determine whether the user device is in a payment location associated with a payment instruction, send payment requests, and provide any of the other functionality that is discussed above. While database 606 has been illustrated as located in device 600, one of skill in the art will recognize that it may be connected to automatic payment engine 604 through a network without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payees and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for making a location-based payment, comprising:
receiving, by a computer system of a payment provider from a user device of a user via an electronic communication network, a location of the user as detected by a GPS component in the user device;
determining that the detected location of the user device satisfies a payment condition corresponding to the user, the payment condition including a presence at the detected location over a period of time;
in response to the determining that the detected location satisfies the payment condition, causing payment for a service associated with the detected location.

2. The method of claim 1, further comprising:
transmitting, by the computer system via the electronic communication network to the user device, a request to make the payment for the service; and
receiving, by the computer system from the user device via the electronic communication network, a confirmation or cancellation of the request.

3. The method of claim 1, further comprising determining, by the computer system, whether the user is current on a payment for the service associated with the detected location.

4. The method of claim 1, wherein the detected location corresponds to a dwelling or business associated with the user.

5. The method of claim 1, wherein the service is a utility service associated with the location.

6. The method of claim 1, wherein the payment is automatically made to a service provider providing the service when the detected location of the user device satisfies the payment condition.

7. The method of claim 1, further comprising notifying, by the computer system, the user that the payment has been made.

8. The method of claim 2, wherein the request comprises information about the service and an amount of the payment.

9. A system for making a location-based payment comprising:
a non-transitory memory storing a payment account of a user;
one or more processors coupled to the non-transitory memory and configured to read instructions from the non-transitory memory to cause the system to perform operations comprising:
receiving, from a user device of the user via an electronic communication network, a location of the user as detected by a GPS component in the user device;
determining that the detected location of the user device satisfies a payment condition corresponding to the user, the payment condition including a presence at the detected location over a period of time;
in response to the determining that the detected location satisfies the payment condition, causing payment for a service associated with the detected location.

10. The system of claim 9, wherein the operations further comprises:
transmitting, via the electronic communication network to the user device, a request to make the payment for the service; and
receiving, from the user device via the electronic communication network, a confirmation or cancellation of the request.

11. The system of claim 9, wherein the operations further comprises determining, whether the user is current on a payment for the service associated with the detected location.

12. The system of claim 9, wherein the detected location corresponds to a dwelling or business associated with the user.

13. The system of claim 9, wherein the service is a utility service associated with the location.

14. The system of claim 9, wherein the payment is automatically made to a service provider providing the service when the detected location of the user device satisfies the payment condition.

15. The system of claim 9, wherein the operations further comprise notifying the user that the payment has been made.

16. The system of claim 10, wherein the request comprises information about the service and an amount of the payment.

17. A non-transitory machine-readable medium having stored thereon machine-readable instructions executable to cause a machine to perform operations comprising:
receiving, from a user device of a user via an electronic communication network, a location of the user as detected by a GPS component in the user device;
determining that the detected location of the user device satisfies a payment condition corresponding to the user, the payment condition including a presence at the detected location over a period of time;
in response to the determining that the detected location satisfies the payment condition, causing payment for a service associated with the detected location.

18. The non-transitory machine-readable medium of claim 17, wherein the operations further comprise determining, whether the user is current on a payment for the service associated with the detected location.

19. The non-transitory machine-readable medium of claim 17, wherein the service is a utility service associated with the location.

20. The non-transitory machine-readable medium of claim 17, wherein the detected location corresponds to a dwelling or business associated with the user.
